(19) United States
(12) Patent Application Publication
(10) Pub. No.: US 2006/0126122 A1
(43) Pub. Date: Jun. 15, 2006

(54) Device for supporting lid of office machine

(76) Inventors: Kun-Yee Yang, Kweishan (TW); Ming-Tsung Cheng, Kweishan (TW)

Correspondence Address: HOFFMAN WARNICK & D'ALESSANDRO, LLC, 75 STATE STREET, 14TH FL, ALBANY, NY, 12207, US

(21) Appl. No.: 11/301,621

(22) Filed: Dec. 13, 2005

(30) Foreign Application Priority Data
Dec. 14, 2004 (TW) 093138682

(51) Int. Cl. H04N 1/23

(52) U.S. Cl. 358/296

(57) ABSTRACT

The invention provides a supporting device for assisting supporting a lid of an office machine. The office machine also includes a housing to which the lid is pivotally engaged. The supporting device includes a first main body. When the office machine is set upright on, substantially upright on or upright over a plane, the first main body is capable of being disposed at a position where the lid is capable of rotating to a first angle relative to the housing and being held by a first end of the first main body.

### BACKGROUND OF THE INVENTION

1. Field of the Invention

The invention relates to a supporting device for assisting supporting a lid of an office machine substantially erected.

2. Description of the Prior Art

As the current design for office machines, such as scanners, facsimile machines or multi-function office machines, gravitate towards the short and small, light-weight and thin directions, the desk-top type office machines are already exited nowadays. The current office machine almost equips with a lid. Thereinafter taking a desk-top type scanner as an example to illustrate the operation between the office machine equipped with a lid and the lid. Referring to FIG. 1A, an outside perspective view of a typical desk-top type scanner 1 is schematically illustrated. As shown FIG. 1A, the scanner 1 includes a housing 12 and a lid 14. The housing 12 has a bottom surface 122 and a top surface 124 to which the lid 14 is pivotally engaged.

Referring to FIG. 1B, the drawing shows a side view of the scanner 1 in FIG. 1A. As shown in FIG. 1B, the scanner 1 is capable of being by an edge side 126 of the housing 12 set upright on the plane p (ex. a table) for saving the space occupied by the scanner 2 placed on the plane p.

Referring to FIG. 1C, the drawing is another side view of the scanner 1 in FIG. 1A. As shown in FIG. 1C, the scanner 1 also includes a supporting shaft 16. The supporting shaft 16 via an end 162 thereof is pivotally engaged to the bottom surface 122 of the housing 12. The scanner 1 is capable of being substantially set upright on the plane p by an edge side 126 thereof and the supporting shaft 16 been retracted relative to the bottom surface 122 of the housing 12 for saving space occupied by the scanner 1 placed on the plane p.

For saving the space occupied by the scanner 1 as well, as shown in FIG. 1D, the scanner 1 can install a hanging device 18. The hanging device 18 is capable of hanging on a wall w perpendicular to the plane p such that the scanner 1 is set upright over the plane p.

As shown in FIGS. 1B, 1C and 1D, when the scanner 1 is set upright on, substantially upright on or upright over the plane p, the lid 14 is capable of rotating to a specific angle relative to the housing 12 in order to put the object to be scanned on the scan region of the housing 12. However, as for the mentioned-above designs, the hinge between the lid 14 and the housing 12 is complicated to design. If the user rotates the lid 14 over the specific angle, the lid 14 will totally open in a twinkle and even broke the hinge between the lid 14 and the housing 12. With the increase of the use time, the hinge between the lid 14 and the housing 12 would be also worn away such that the lid 14 can't be orientated at the specific angle.

Accordingly, an objective of the invention is to provide a supporting device for assisting supporting a lid of an erected office machine.

### SUMMARY OF THE INVENTION

According to the first preferred embodiment, a supporting device is for assisting supporting a lid of an office machine. The office machine also includes a housing to which the lid is pivotally engaged. The supporting device includes a first main body, and when the office machine is set upright on, substantially upright on or upright over a plane, the first main body is capable of being disposed at a position where the lid is then capable of rotating to a first angle relative to the housing and being held by a first end of the first main body. At the same time that the lid is held by the first end of the first main body, the first main body also via a second end abuts upon the plane.

According to the second preferred embodiment, a supporting device is for assisting supporting a lid of an office machine. The office machine also includes a housing to which the lid is pivotally engaged. The supporting device includes a first main body, and when the office machine is set upright on, substantially upright on or upright over a plane, the first main body is capable of being disposed at a position where the lid is then capable of rotating to a first angle relative to the housing and being held by a first end of the first main body. The supporting device also includes a second main body having a first end and a second end. The second main body is via the first end thereof pivotally engaged to the housing. The first main body extends from the second end of the second main body and is substantially perpendicular to the second main body. Before the first main body is disposed at the position, the second main body is retracted relative to the housing.

The advantage and spirit of the invention may be understood by the following recitations together with the appended drawings.

### BRIEF DESCRIPTION OF THE APPENDED DRAWINGS

FIG. 1A shows an outside perspective view of a typical desk-top scanner 1.

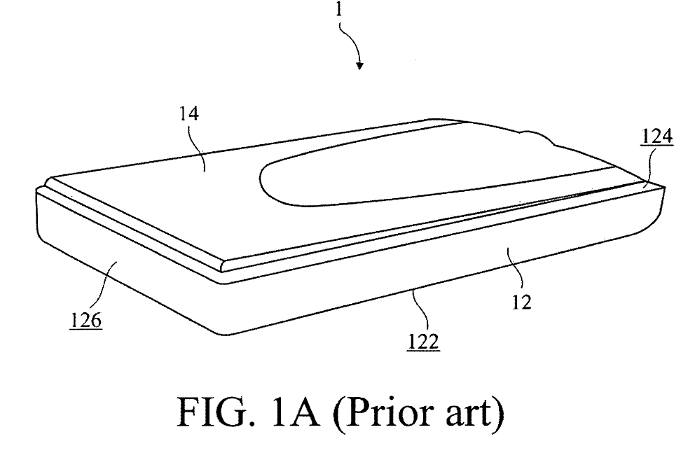

FIG. 1B shows a side view of the scanner 1 in FIG. 1A wherein the scanner 1 is capable of being set upright on the plane p by an edge side 126 thereof the housing 12.

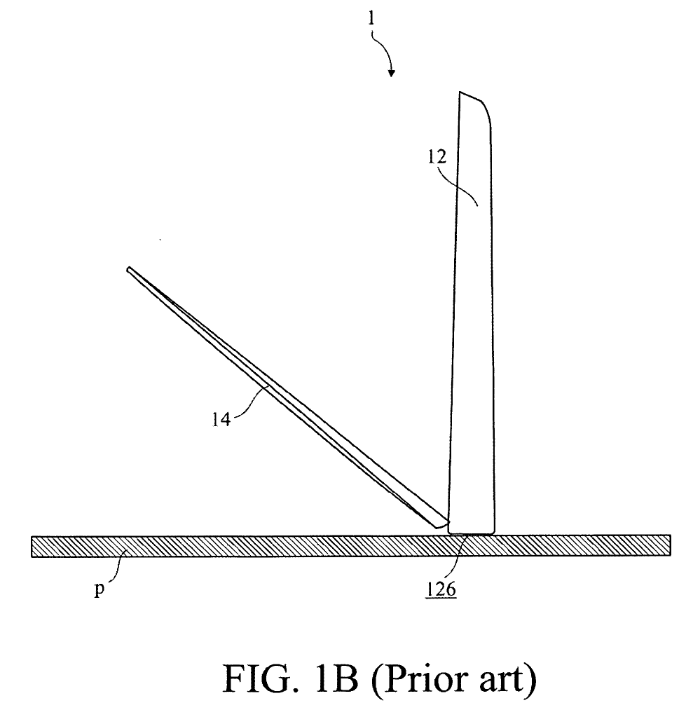

FIG. 1C shows another other side view of the scanner 1 in FIG. 1A wherein the scanner 1 is capable of being substantially set upright on the plane p by a supporting shaft 16.

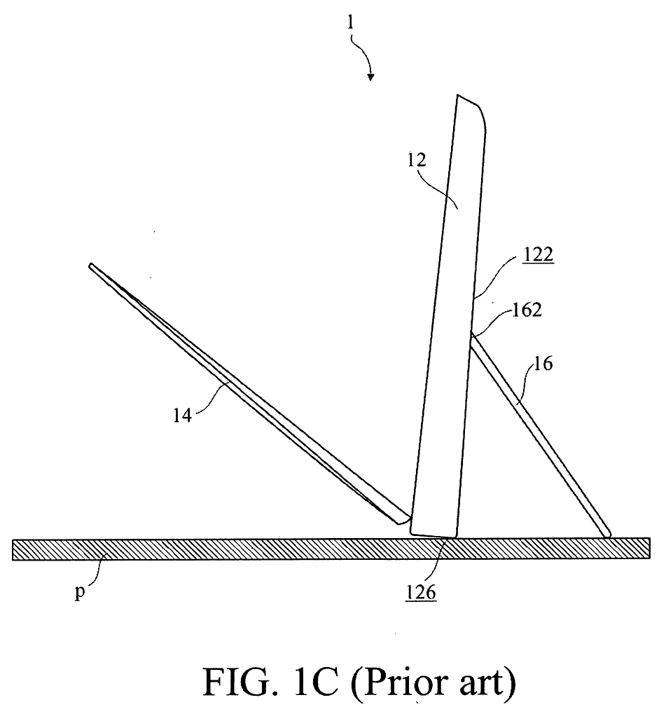

FIG. 1D shows another side view of the scanner 1 in FIG. 1A wherein the scanner 1 is capable of hanging on a wall w perpendicular to the plane p by a hanging device 18.

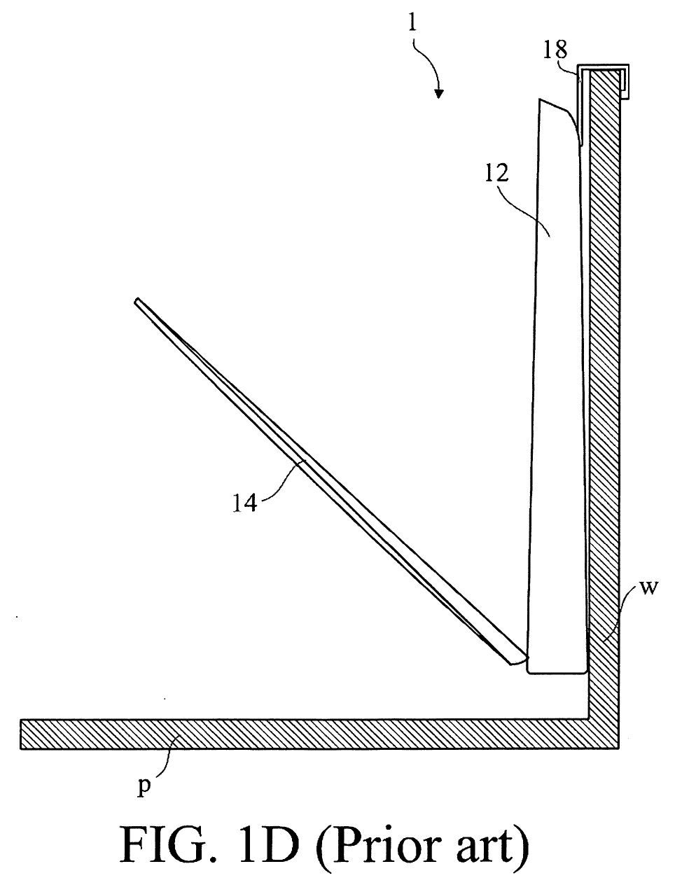

FIG. 2A shows an outside perspective view of a desk-top scanner 2, the scanner 2 also includes the supporting device 3 according to the first preferred embodiment of the invention.

FIG. 2B shows a side view of the scanner 2 in FIG. 2A wherein the scanner 2 is capable of being set upright on the plane P by an edge side 226 thereof the housing 22.

FIG. 2C shows another side view of the scanner 2 in FIG. 2A wherein the scanner 2 is capable of being substantially set upright on the plane P by a supporting shaft 26.

FIG. 2D shows another side view of the scanner 2 in FIG. 2A wherein the scanner 2 is capable of hanging on a wall W perpendicular to the plane P by a hanging device 28.

FIG. 3A shows an outside perspective view of a desk-top scanner 4, the scanner 4 also includes the supporting device 5 according to the second preferred embodiment of the invention.

FIG. 3B shows a side view of the scanner 2 in FIG. 3A wherein the scanner 4 is capable of being set upright on the plane P′ by an edge side 426 thereof the housing 42.

FIG. 3C shows another side view of the scanner 4 in FIG. 3A wherein the scanner 4 is capable of being substantially set upright on the plane P′ by a supporting shaft 46.

FIG. 3D shows another side view of the scanner 4 in FIG. 3A wherein the scanner 4 is capable of hanging on a wall W′ perpendicular to the plane P′ by a hanging device 48.

### DETAILED DESCRIPTION OF THE INVENTION

The invention provides a supporting device for assisting supporting a lid of an office machine. The office machine, like a typical office machine, includes a housing to which the lid is pivotally engaged. The characteristic of the invention is the supporting device in accordance with the invention includes a first main body. When the office machine is set upright on, substantially upright on or upright over a plane, the first main body is capable of being disposed at a position where the lid is capable of rotating to a first angle relative to the housing and being held by a first end of the first main body.

Thereinafter taking a desk-top type scanner as an example to illustrate the operation between the office machine equipped with a lid and the lid and indicate the characteristic and spirit of the invention by reciting several preferred embodiments of the invention.

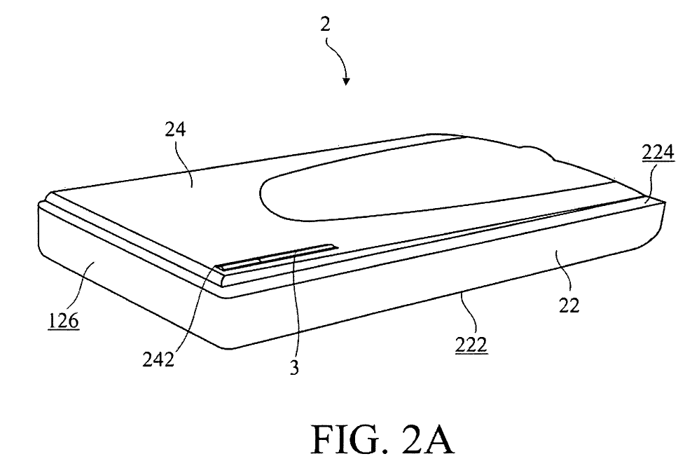

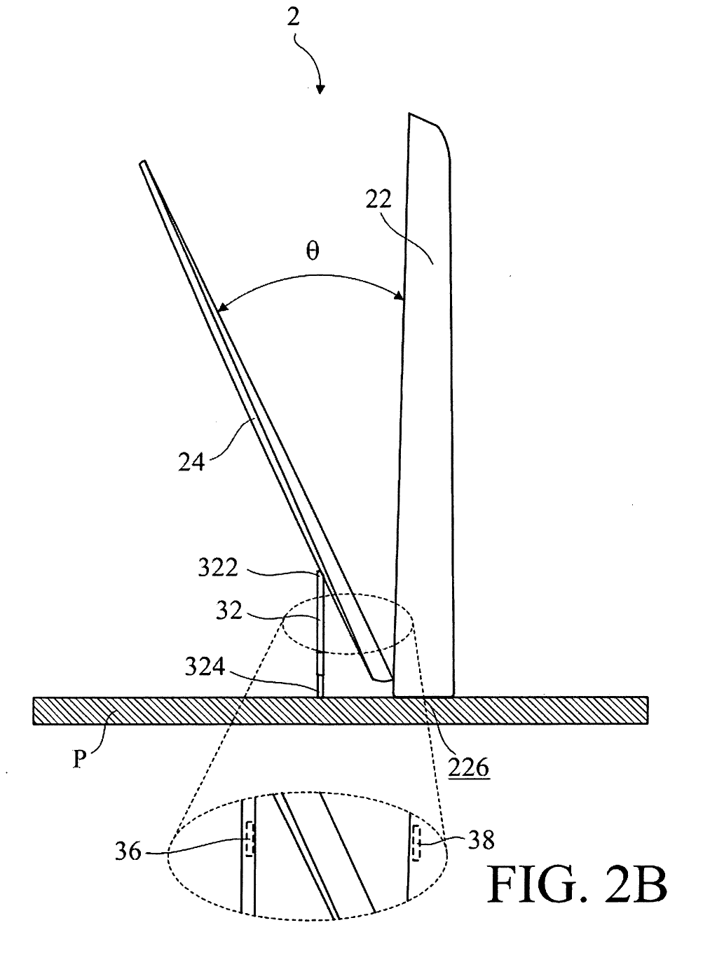

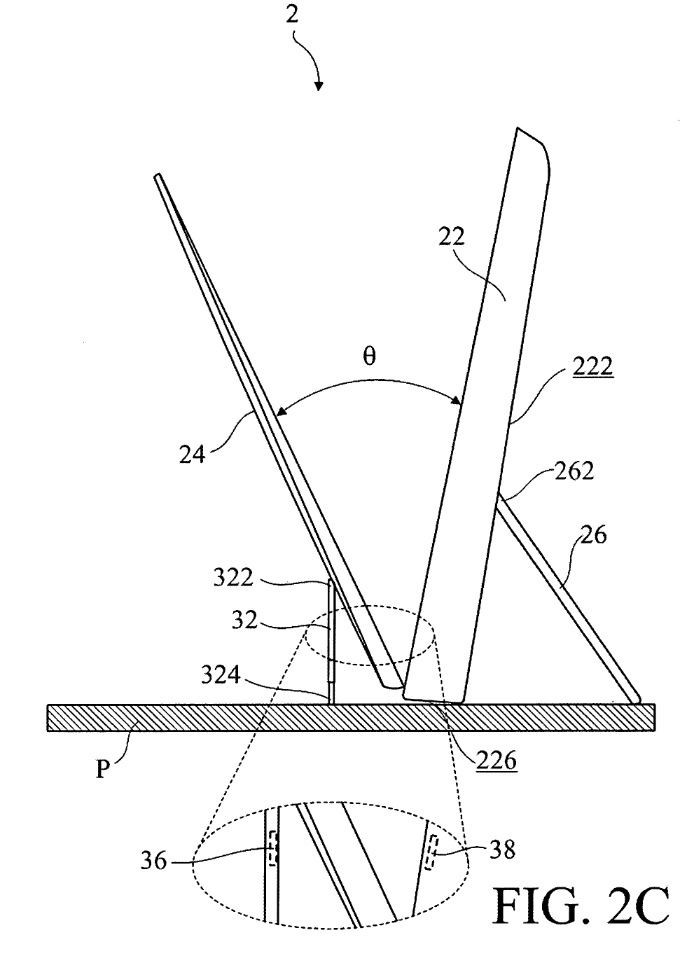

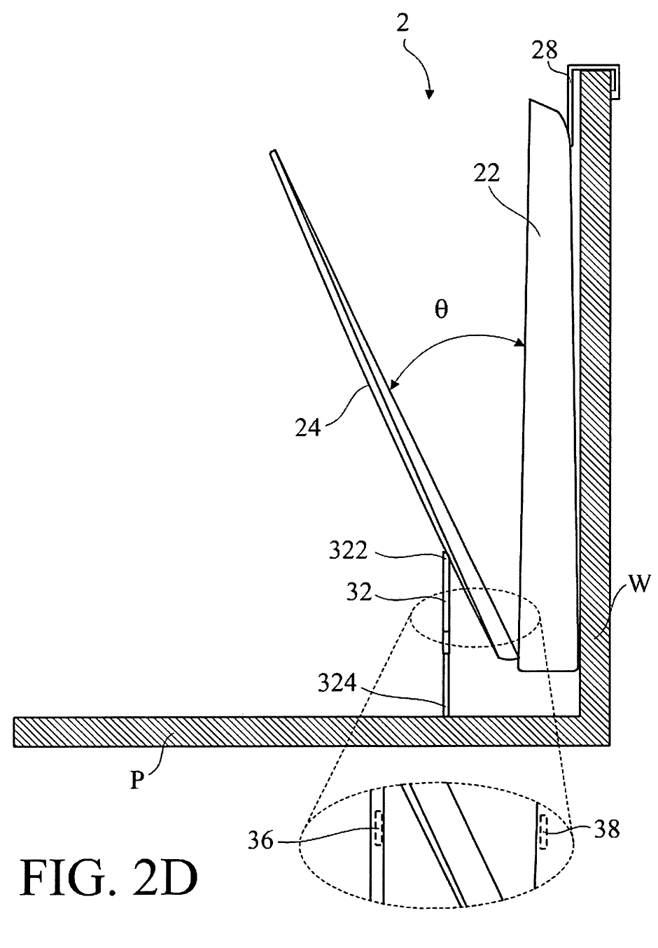

Referring to FIGS. 2A through 2D, the supporting device 3 according to the first preferred embodiment of the invention is disclosed. FIG. 2A shows an outside perspective view of a desk-top scanner 2, the supporting device 3 is used for assisting supporting a lid 24 of the scanner 2. As shown in FIG. 2A, the scanner 2 also includes a housing 22. The housing 22 has a bottom surface 222 and a top surface 224 to which the lid 24 is pivotally engaged.

Referring to FIG. 2B, the drawing shows a side view of the scanner 2 in FIG. 2A. As shown in FIG. 2B, the scanner 2 is capable of being set upright on the plane P (ex. a table) by an edge side 226 thereof the housing 22 for saving the space occupied by the scanner 2 placed on the plane P.

Referring to FIG. 2C, the drawing is another side view of the scanner 2 in FIG. 2A. As shown in FIG. 2C, the scanner 2 also includes a supporting shaft 26. The supporting shaft 26 via an end 262 thereof is pivotally engaged to the bottom surface 222 of the housing 22. The scanner 2 is capable of being substantially set upright on the plane P by an edge side 226 thereof and the supporting shaft 26 been retracted relative to the bottom surface 222 of the housing 22 for saving the space occupied by the scanner 2 placed on the plane P.

For saving the space occupied by the scanner 2 as well, as shown in FIG. 2D, the scanner 2 can install a hanging device 28 capable of hanging on a wall W perpendicular to the plane P such that the scanner 2 is set upright over the plane P.

The supporting device 3 includes a first main body 32. As shown in FIG. 2B, FIG. 2C and FIG. 2D, when the scanner 2 is set upright on, substantially upright on or upright over a plane P, the first main body 32 is capable of being disposed at a position where the lid 24 is then capable of rotating to a first angle θ relative to the housing 22 and being held by a first end 322 of the first main body 32, at the same time the first main body 32 also via a second end 324 abuts upon the plane P.

In one embodiment, as shown in FIG. 2A, the lid 24 thereon has a groove 242 for accommodating the supporting device 3. The supporting device 3 is via the first end 322 of the first main body 32 pivotally engaged in the groove 242.

In one embodiment, as shown in FIGS. 2B, 2C and 2D, the supporting device 3 further comprising a first means 36, disposed on the first main body 32, and a second means 38 disposed on the housing 22. When the first means 36 is apart from the second means 38 within a critical distance, a magnetic force acts between the first means 36 and the second means 38 such that the first main body 32 is retained in the groove 242. When the first means 36 is apart from the second means 38 at the critical distance, the lid 24 is rotated to a second angle less than the first angle θ relative to the housing. In the practice application, the first means 36 and the second means 38 can separately be a magnet.

In one embodiment, as shown in FIGS. 2B, 2C and 2D, the supporting device 3 thereof is retractable and has an adjustable length on which the first angle θ depends.

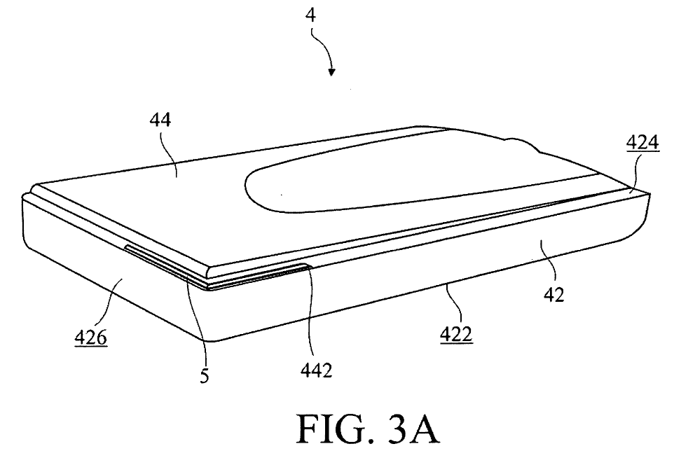

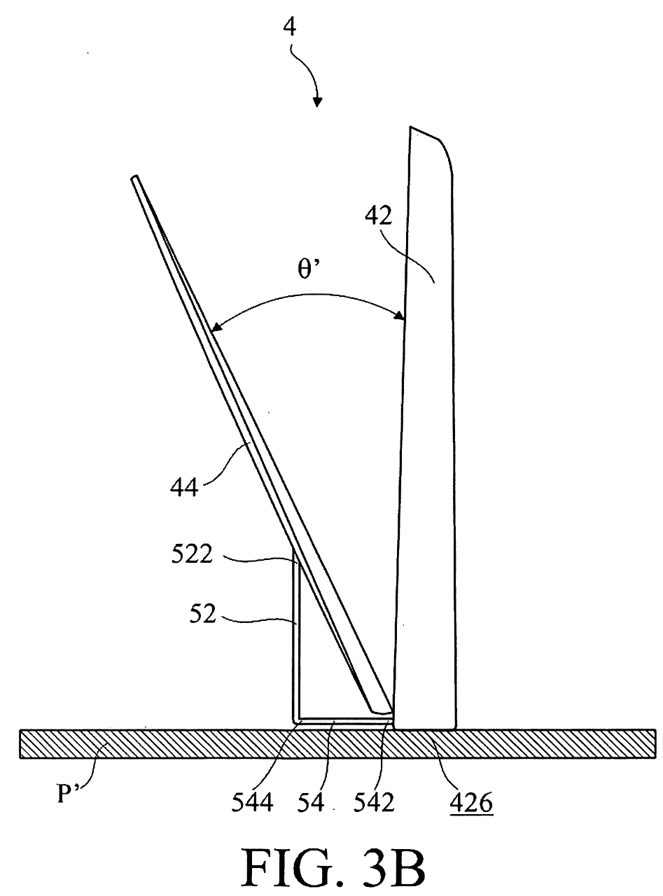

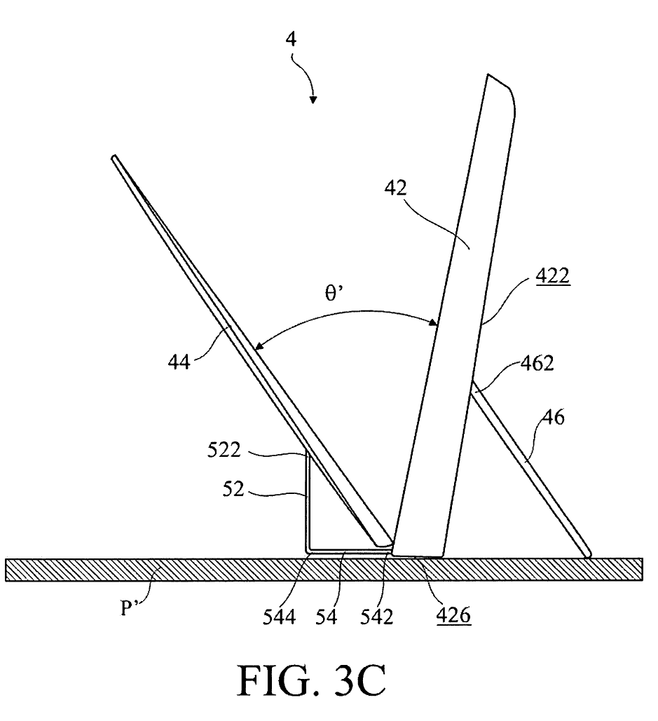

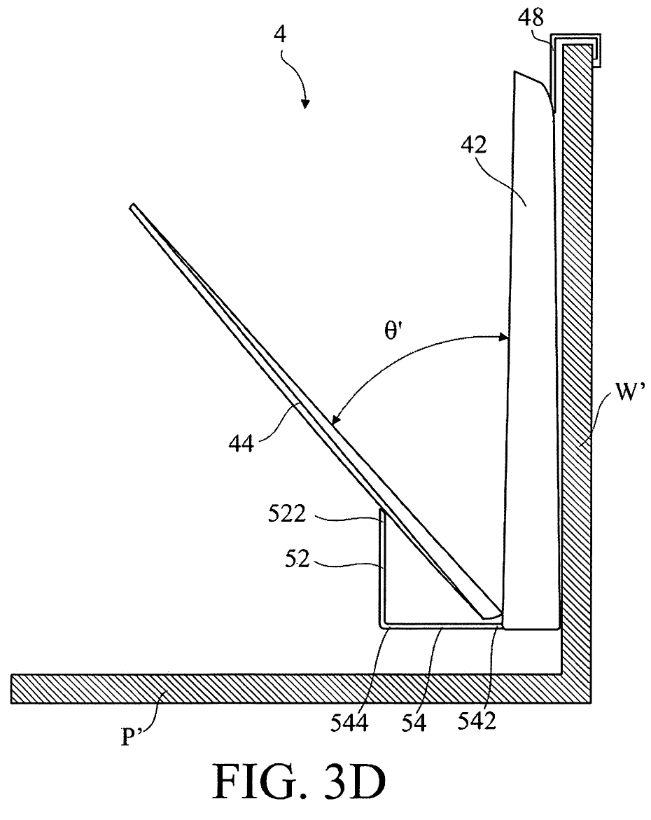

Referring to FIG. 3A to FIG. 3D, the supporting device 5 according to the second preferred embodiment of the invention is disclosed. FIG. 3A shows an outside perspective view of a desk-top scanner 4, the supporting device 5 is used for assisting supporting a lid 44 of the scanner 4. As shown in FIG. 3A, the scanner 4 also includes a housing 42. The housing has a bottom surface 422 and a top surface 424 to which the lid 44 is pivotally engaged.

Referring to FIG. 3B, the drawing shows the side view of the scanner 4 in FIG. 3A. As shown in FIG. 3B, the scanner 4 is capable of being set upright on the plane P′ (ex. a table) by an edge side 426 thereof the housing 42 for saving the space occupied by the scanner 4 placed on the plane P′.

Referring to FIG. 3C, the drawing is the other side view of the scanner 4 in FIG. 3A. As shown in FIG. 3C, the scanner 4 also includes a supporting shaft 46. The supporting shaft 46 via an end 462 thereof is pivotally engaged to the bottom surface 422 of the housing 42. The scanner 4 is capable of being substantially set upright on the plane P′ by an edge side 426 thereof and the supporting shaft 46 been retracted relative to the bottom surface 422 of the housing 42 for saving the space occupied by the scanner 4 placed on the plane P′.

For saving the space occupied by the scanner 4 as well, as shown in FIG. 3D, the scanner 4 can install a hanging device 48 capable of hanging on a wall W′ perpendicular to the plane P′ such that the scanner 4 is set upright over the plane P′.

As the same as the first preferred embodiment, the supporting device 5 in accordance with the second preferred embodiment also includes a first main body 52. As shown in FIGS. 3B, 3C and 3D, when the scanner 4 is set upright on, substantially upright on or upright over a plane P′, the first main body 52 is capable of being disposed at a position where the lid 44 is then capable of rotating to a first angle θ′ relative to the housing 42 and being held by a first end 522 of the first main body 52.

As shown in FIGS. 3B, 3C and 3D, the supporting device 5 in accordance with the second preferred embodiment also includes a second main body 54 having a first end 542 and a second end 544. The second main body 54 being via the first end 542 thereof pivotally engaged to the housing 42, and wherein the first main body 52 extends from the second end 544 of the second main body 54 and is substantially perpendicular to the second main body 54, before the first main body 52 is disposed at the position, the second main body 54 is retracted relative to the housing 42.

In one embodiment, the housing 42 has an L-shaped groove 442 for accommodating the first main body 52 and the second main body 54, the first end 542 of the second main body 54 is pivotally engaged in the groove 442.

In one embodiment, at least one of the first main body 52 and the second main body 54 is retractable and has an respective adjustable length on which the first angle θ′ depends.

To sum up, the description of the above-mentioned preferred embodiments is for providing a better understanding on the strengths and spirits of this present invention, not for limiting the domain of the invention. Moreover, it aims to include various modification and arrangement parallel in form into the domain of the patent applied by this present invention. Due to the above mentioned, the domain of the patent applied by the invention should be explained in a macro view to cover all kinds of possible modification and arrangement of equal form.

What is claimed is:

1. An office machine, comprising:
a housing;
a lid, pivotally engaged to the housing; and
a supporting device comprising a first main body, and wherein when said office machine is set upright on, substantially upright on or upright over a plane, the first main body is capable of being disposed at a position where the lid is capable of rotating to a first angle relative to the housing and being held by a first end of the first main body.

2. The office machine of claim 1, wherein the first main body is via the first end thereof pivotally engaged to the lid, at the same time that the lid is held by the first end of the first main body, the first main body also via a second end abuts upon the plane.

3. The office machine of claim 2, wherein the lid thereon has a groove for accommodating the first main body, and the first end of the first main body is pivotally engaged in the groove.

4. The office machine of claim 3, further comprising a first means, disposed on the first main body, and a second means disposed on the housing, and wherein when the first means is apart from the second means within a critical distance, a magnetic force acts between the first means and the second means such that the first main body is retained in the groove, when the first means is apart from the second means at the critical distance, the lid is rotated to a second angle less than the first angle relative to the housing.

5. The office machine of claim 4, wherein said supporting device thereof is retractable and has an adjustable length on which the first angle depends.

6. The office machine of claim 5, wherein the housing has a bottom surface and a top surface to which the lid is engaged, said office machine also comprises a supporting shaft via an end thereof pivotally engaged to the bottom surface of the housing, said office machine is capable of being set substantially upright on the plane by an edge side thereof and the supporting shaft been retracted relative to the bottom surface of the housing.

7. The office machine of claim 5, further comprising a hanging device capable of hanging on a wall perpendicular to the plane such that said office machine is set upright over the plane.

8. The office machine of claim 1, further comprising a second main body having a first end and a second end, the second main body being via the first end thereof pivotally engaged to the housing, and wherein the first main body extends from the second end of the second main body and is substantially perpendicular to the second main body, before the first main body is disposed at the position, the second main body is retracted relative to the housing.

9. The office machine of claim 8, wherein the housing has an L-shaped groove for accommodating the first main body and the second main body, the first end of the second main body is pivotally engaged in the groove.

10. The office machine of claim 9, wherein at least one of the first main body and the second main body is retractable and has a respective adjustable length on which the first angle depends.

11. The office machine of claim 10, wherein the housing has a bottom surface and a top surface to which the lid is engaged, said office machine also comprises a supporting shaft via an end thereof pivotally engaged to the bottom surface of the housing, said office machine is capable of being set substantially upright on the plane by an edge side thereof and the supporting shaft been retracted relative to the bottom surface of the housing.

12. The office machine of claim 10, wherein said office machine further comprises a hanging device capable of hanging on a wall perpendicular to the plane such that said office machine is set upright over the plane.
